(19) United States
(12) Patent Application Publication
(10) Pub. No.: US 2005/0235266 A1
(43) Pub. Date: Oct. 20, 2005

(54) System and method for business rule identification and classification

(75) Inventors: Ioan Oara, Cary, NC (US); Alex Rukhlin, Cary, NC (US); Kevin Cruz, Morrisville, NC (US)

Correspondence Address: DANIELS DANIELS & VERDONIK, P.A., SUITE 200 GENERATION PLAZA, 1822 N.C. HIGHWAY 54 EAST, DURHAM, NC, 27713, US

(73) Assignee: Relativity Technologies, Inc., Raleigh, NC (US)

(21) Appl. No.: 10/827,953

(22) Filed: Apr. 20, 2004

(51) Int. Cl. G06F 9/44

(52) U.S. Cl. 717/126

(57) ABSTRACT

A system and method is used to identify all business rules in program code, particularly legacy program code. Business rules in program code generally fall into two categories, i.e., rules related to program input and rules related to program output. All input ports and output ports in a program are identified. For input ports, the outgoing data flow is identified, and for each field in the data flow, a determination is made about whether a test is used to branch the program. If a test exists, the rule is identified and stored. In a case of output business rules, all output ports in the program are identified, the data structure associated with each output determined or each field and data structure, the computation path is determined. If the computation path is not empty, an output business rule is created and stored.

### FIELD OF THE INVENTION

This invention relates to a method and system for identifying business rules in program code, namely, legacy code, such as COBOL, PLI, NATURAL and other languages. More specifically, the invention relates to a method of identifying business rules through the identification of input and output ports in program code.

### BACKGROUND OF THE INVENTION

Legacy applications may contain large volumes of code. As time passes, knowledge about the code may be lost for various reasons, including the fact that the original developers of the code are no longer working for the company for which the program was developed. To the extent that legacy code continues to be used in company operations, it is important that the existing legacy code be analyzed and understood, particularly for updates and adaptations necessary to the evolution of the company.

More specifically, legacy code may contain technical artifacts which are helpful in the implementation and usually contains some logic directly related to the business of the company in which the code is used. The identification of this logic is especially important. For purposes of the discussion herein, it is noted that such fragments of code which implement particular business requirements are usually called “business rules”.

This is important for a number of reasons, including the fact that the business of the company may change, and such business rules may be required to be modified to reflect more modern business operations. Due to the fact that the legacy code was written, in often cases, many years prior to the need to change the business rule or understand the business rule, identification of the portions of the code in which the rule resides may be difficult if not impossible.

This is further complicated by the fact that in many cases, the program embodying the legacy code was written in an unstructured manner so that the business rules are populated throughout the program in an unstructured and often unpredictable manner.

In accordance with the invention, a method is provided which allows easy identification and classification of the business rules in such programs, including classifying the business rule and storing information about where the business rule is located for further use, particularly for legacy programs.

### SUMMARY OF THE INVENTION

In accordance with one aspect of the invention, there is provided a method of identifying business rules. More specifically, the method provides for identifying business rules relating to both inputs and outputs in program code of, for example, legacy programs.

With respect to identification of business rules relating to inputs in a program, the method involves identifying all input ports in a program code. The data structure associated with each input port is then determined, and for each field in each input port, the outgoing data flow is determined. For each such field in the data flow, a determination is made about whether there is a test used to branch in the program. If a test exists, a validation rule (which is a business rule identified as associated with an input port) is created and the rule is stored.

In another aspect, there is provided a method of identifying business rules relating to outputs in program code of a program. The method involves identifying all output ports in the program. For each output port, the data structure associated with each output port is determined and for each field in each output port, the computation path is also determined. A further determination identifies whether the path is not empty, and if the computation path is not empty, a computation rule (which is a business rule identified as associated with an output port and its computation path) is created and the rule is stored.

In a yet still further aspect, the method involves identifying business rules relating to both inputs and outputs in program code of a program, and involves the aforementioned combination of steps.

In a yet further aspect, the invention relates to a system for identifying business rules relating to inputs and outputs in a program. The system includes an interface, for example, a display for displaying all input ports and all output ports in the program code. The display can be associated with a computer, having the program code loaded thereon and programmed for finding and displaying the input ports and output ports. The interface further includes means for determining the data structure associated with each input port and with each output port. There are also means for determining the outgoing data flow for each field in each input port, and means for determining the computation path for each field in each output port. In addition, the system includes means for determining whether a test is used to branch in the input port outgoing data flow, and means for creating a validation rule and storing the validation rule if a test exists. Finally, the system also includes means for determining if the computation path is not empty for each computation path of each output data port, and means for creating a computation rule and for storing the computation rule if the computation path is not empty.

With respect to the various means identified, as may be appreciated, they can be implemented on a computer with display and input device, which has been programmed to achieve the function of the various means in accordance with the more detailed description which follows.

### BRIEF DESCRIPTION OF THE DRAWINGS

Having thus briefly described the invention, the same will become better understood from the following detailed discussion, made with reference to the accompanying drawing, wherein:

FIG. 1 is a block diagram illustrating how a parsing of a legacy program can be used to identify business rules in program code;

FIG. 2 is a screenshot of how a user can locate rules manually or automatically;

FIG. 3 is a screenshot illustrating an implementation of the detection of output or computation rules in program code;

FIG. 4 is a block diagram illustrating how input rules in program code are identified, and a rule created and stored for later use; and

FIG. 5 is a block diagram illustrating how output rules in program code are identified, created and stored for later use.

### DETAILED DISCUSSION OF THE INVENTION

As previously discussed, in accordance with the method described herein, there is provided a practical method of identifying business rules in program code, particularly legacy code, including COBOL, PLI, NATURAL and other languages.

As already discussed, many programs, and in particular legacy applications may contain large volumes of code. Knowledge about the code may have been lost for a number of reasons, including the fact that developers of the original code are no longer working for the company. It is therefore important for continuing operations of a company that the legacy code be analyzed and understood.

In implementing the invention, it becomes important to appreciate that programs, and especially legacy code, may contain technical artifacts which are helpful in the implementation and usually contain some logic directly related to the business of the company. An identification of the logic is particularly important, and the fragments of code which implement particular business requirements are usually called business rules. The problem solved by the invention is identification of “business rules” of the program, particularly legacy applications, and determining the meaning of the business rule.

As previously noted, the invention can be implemented, for example, on a computer with a display, memory, storage and input devices, etc., programmed to operate as described herein as a system having various program modules or portions as means to achieve the described functions.

We consider here that business rules fall into two categories. Generally, these categories are 1) rules related to program inputs, and 2) rules related to program outputs. The rules related to input data are usually “validations” and they describe some restrictions on the data. The rules related to output data are usually “computation” rules that show how to compute a value or how to make a decision. Decisions and computations are essentially of the same nature, a decision being a computation of a binary value field, i.e., Yes or No.

As further example with respect to input rules in a program, it is noted that for input ports, programs have statements on how data is received. Such statements can be viewed by examination of the program code on screen or in a file or through specific means such as the use of another program such as a standard and conventional parsing program. Each statement has a syntax which can be recognized by certain keywords, for example, a “read”, or a “call” or a “receive.” There are also data structures which store or hold data which is read into the program. The way in which most programs work is that a data structure is declared (specifying it's name, size, subfields, etc.) data is then read and put into the data structure. The fields in the data structure are then tested to determine its validity. For example, a program may receive information from a screen, including phone numbers, which must have at least seven numbers. The program checks the number of digits in the phone number. If the phone number is less than seven digits, a message is issued by the program and posted on the screen. The fact that an input field is verified and a message is issued identifies this portion of code as a business rule. The business rule is named in accordance with the function it provides and pointers are set and stored to identify the start and the end of the business rule in the code.

With respect to output rules, they are generally identified through the detection of output ports. The output ports issue a “write” or “send” statement. The output rules refer to data associated with the output ports. This is contrasted with input rules which are associated with input ports.

For the output ports, the data structure is identified as before. The location of the data fields is identified and the computation path which ends in the output port is determined. The computation path consists of all statements of the program which have an influence on the field at a particular point in the program. If no computation path is found, then there is no business rule. On the other hand, if a computation path is found, then the business rule is identified and pointers are set to the start and the end of each fragment of the code in the computation path. The rule is named and stored.

As a further example of a computation rule, in the case of an insurance program an operator may enter data relating to the date of birth of a potential insured party. After the date of birth of the party is entered, the program code computes the age of the party, and for example, if below a certain age, would relay the statement to the output port that the party is not approved because the party is underage.

Thus, as may be appreciated, and already discussed, all business rules fall into two categories, rules related to program inputs, and rules related to program outputs.

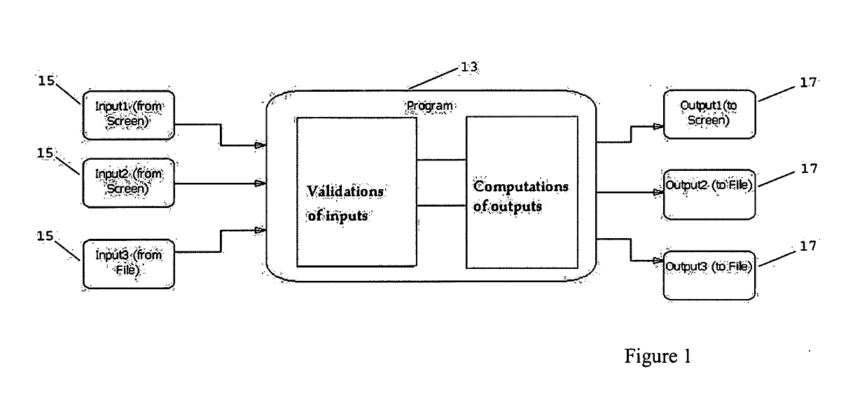

As further illustrated in FIG. 1, in analyzing the program, it is important to appreciate that a program 13 receives data from outside, such as input from screens 15. The program 13 uses the “input” business rules to validate that the data received is correct and that the program can proceed to compute the outputs. If the data is not correct, a message is issued. The “output” business rules compute the outputs of the program and the output data is sent to a screen, file or another device 17.

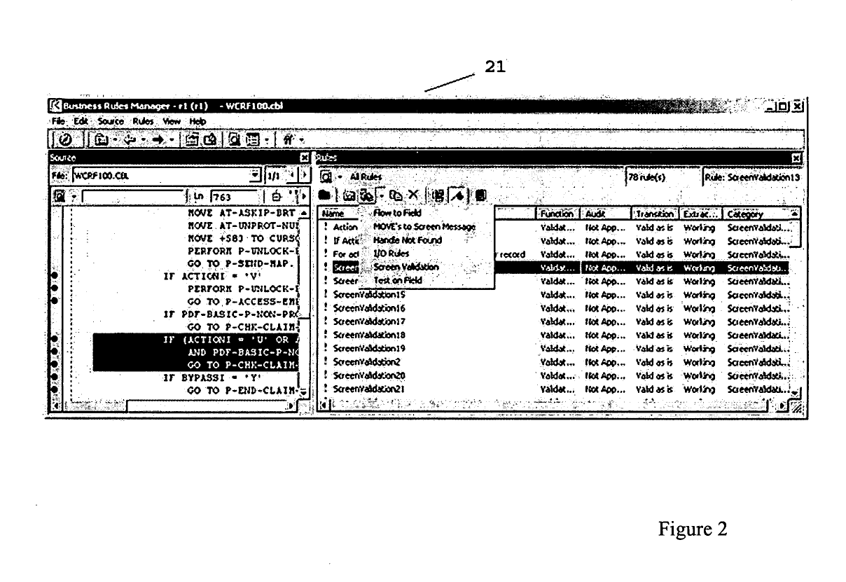

As shown in FIG. 2, in implementing the rule identification process, a user may locate rules manually or automatically by selecting from one of the methods displayed in the menu.

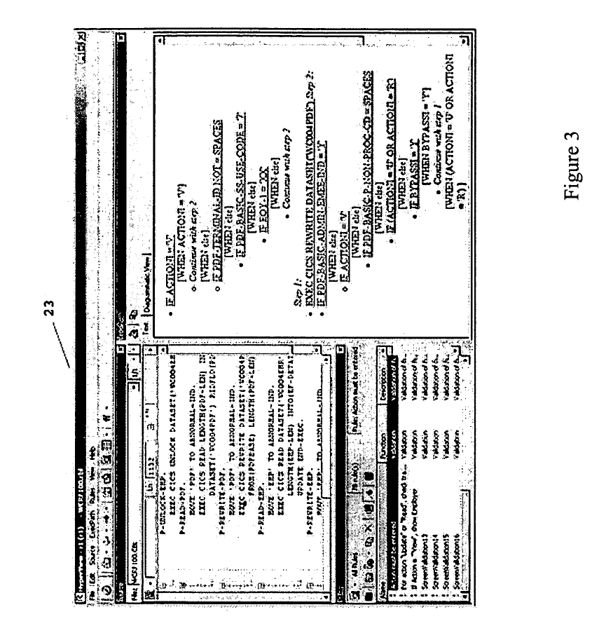

In FIG. 3, implementation of “output” rule detection involves a user statement in the program 23 (seen on the left), and the system detects all the conditions leading to the execution of the statement.

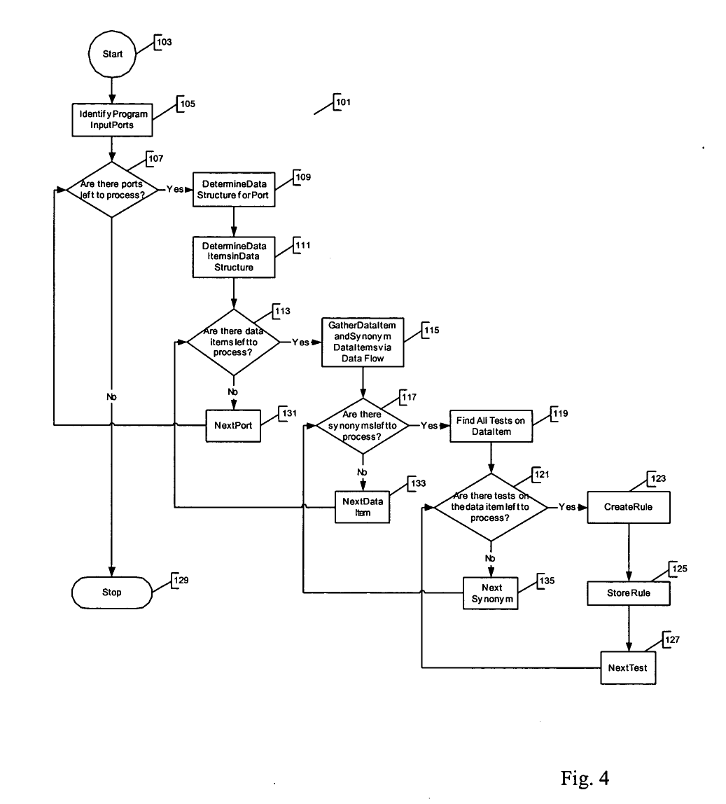

The method of detecting input rules is illustrated in greater detail in FIG. 4, which is a block diagram 101 of the steps taken in determining the input business or validation rules. The method starts at step 103, where it is assumed that the program was parsed using common parsing techniques which extract internal program information and is available for some automatic analysis. At step 105, all of the input ports in the program are identified, either by manual inspection or by use of conventional parsing programs. Then each input port is inspected. More specifically at step 107 a check is made if any not inspected ports are left and a next input port is investigated. If no more input ports are left the method stops at step 129. For the input port selected at step 107, the data structure for that input port is determined at step 109. At step 111 all data items of the data structure are detected. Then each data item is processed. At step 113 a check is made to determine if any not processed data items are left in the data structure, and a next data item is taken into account. If no data items are left, the method continues with the next port at step 131. At step 115 for the data item selected at step 113, a set is created, which consists of the data item itself and all data items receiving values from the original one via dataflow in the program. Then all the elements of this set are investigated. At step 117 a check is made to determine if elements not yet processed are left in the set, and a next element is then processed. If no such element is found the method continues with the next data item at step 133. Step 119 finds all tests to be conducted on the element. Step 121 checks if there are any tests on the element left to process, i.e. data item or its synonym, and for each of them creates a rule at step 123, stores it at step 125 and continues with the next test at step 127. If there were no tests or all of them are already stored as rules, the method continues with the next element at step 135.

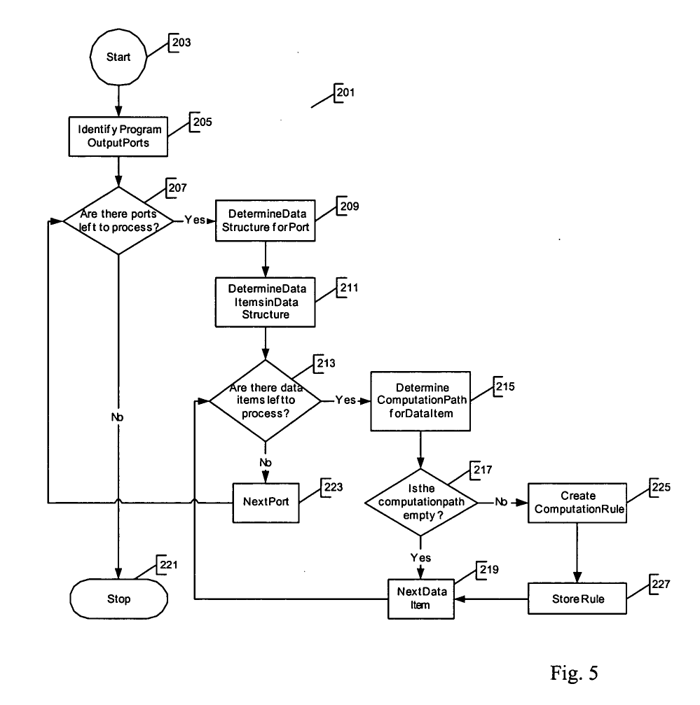

In FIG. 5, block diagram 201 illustrates how output rules in program code are detected, created and stored. The method starts at step 203, where it is assumed that the program was parsed and is available for some automatic analysis. At step 205, all output ports are identified, either by manual inspection or by use of conventional parsing programs. Then each input port is inspected. More specifically, step 207 a check is made to determine if any ports not yet inspected are left and a next output port is investigated. If no more output ports are left, the method stops at step 221. For the output port selected at step 207, the data structure for that output port is determined at step 209. At step 211 all data items of the data structure are detected. Then each data item is processed in the following steps. At step 213 a check is made to determine if any not processed data items are left in the data structure and a next data item is taken into account. If no data items are left, the method continues with the next port at step 223. At step 215 for the data item selected at step 213, its computational path for it is determined. At step 217 a check is made to determine whether the path is empty. If is the path is empty, the method continues with the next data item at step 219. If the path is not empty, then at step 225 the process creates a rule, which is stored at step 227. The method continues then with the next data item at step 219.

For both input and output rules, the method in accordance with the invention captures the business rule, including the name, the field to which it applies, the specific port to which it is associated, i.e., “read”, or “write”. The method also determines a classification of the rule, such as “validation”, “computation”, “decision”, etc. and stores pointers back to the program code so that a user may review the code in order to understand it better.

In addition to these attributes of the rule, which are determined automatically by the system using a conventional parsing program, for example, other attributes may be determined such as “free format description”, “message issued”, or “audit status”.

As already noted, the storing of the rule may include storing information about the rule and where it is located in the program. More specifically, such information may include the program name, starting line numbers and ending line numbers. As already noted, the business rules can be identified by automatically inspecting the code of a program, or may be done manually. The specification of the business rule may also involve storing pointers back to the program code, i.e., where the code fragments which implement the rule start and end. In a yet still more specific aspect, the stored input rule may be given a name selected from one of the name of the input data port and the field being tested.

With respect to the output business rules, the determination of the computation path may further involve determining all statements required to arrive at the value of a field before it is sent out of the program through the output data port. As in the case with the input rule, the storing of the rule and information about where the rule is located may include the program name, starting line number and ending line number. The business rule may also be classified as is the case of the input business rules, and pointers stored back to the program code. Similarly to the input business rules, the stored rule may be given a name selected from one of the name of the output data port and the original field in the upward data structure. The rule may be identified by automatically inspecting the code of the program or may be done by manually inspecting the code of the program.

After a business rule is identified, the system may collect additional information about it. Having pointers to the code fragments which implement the rule, it may automatically compute which are the input and output data elements of the rule itself. For instance, if a rule computes the age of a person based on the birth date and current date, the system may determine automatically that the inputs to the rule are the birth date and current date and that the output of the rule is the age. The input data elements are identified as those referred by the rule, which are initialized somewhere outside of the code fragments of the rules, but do not receive any value in the rule. The output data elements are those which are initialized in the code segments of the rule, and only referred outside those code fragments, without receiving any assignments outside these code segments.

More specific implementations may be used to identify, specify and classify the rules.

One such implementation is to use the field which contains the message issued to the user after a validation. The message field is in fact an output. However, the computation rule for the message is really a validation rule, usually associated with output data. For example, the system may discover that somewhere in the program a test is performed on the state portion of an address and a message is created which tells the user that the “state is invalid”. The validation rule is determined by the assignment to the message field and by the test which leads to that assignment. The name of the rule could be automatically determined by the content of the message, for instance “SEX MUST BE F OR M”.

Another method is based on identifying special “HANDLE” conditions. The “HANDLE” conditions are syntactic constructs in a program which tell the program what it must always do if a particular condition arises. For example, a statement in a program may indicate that if record is not found in a file, then a particular routine should be executed. In this case a rule is identified which points to the “handle” statement and to the routine executed in case the condition in the “handle” statement arises. The name of the rule is formed by the name of the condition (for example “In case of RECORD-NOT-FOUND execute REJECT routine”).

The rules identified by the methods described above may be presented to the user in a number of ways. The simplest form to present the rules is in a list available in a presentation program. The user may click on a rule in the list and the program will show all details of the rule, including the name, classification, rule input and outputs and the corresponding code segments which implement the rule. Alternatively, the rules may be presented in a report which may be printed.

While this presentation of rules is useful, it does not show the rules in the context of the processes in which they are invoked. For instance, it may be important for the user of the system to know that the rule “Phone number must have seven digits” is used exactly at the point when an application for a loan is processed. It may also be important to know that this application acceptance process is run only after, for example, another process is sorting all applications by the state of origin of the applicant. This presentation of rules in the context of a dynamic process is called here contextualization.

In order to contextualize the rules, the system will first automatically create a diagram of internal routines of the program which implements the rules. The construction of such a diagram is commonly known and it exists in a number of software tools which are commercially available. By routines we mean here syntactical constructs of the program which represent units of code that are always executed together. Depending of the language, the routines may be paragraphs (as in the Cobol language), subroutines or functions (as in the PL/1 language) or methods (as in C++ or Java). In the context of this invention we will call these routines “processes.” This process diagram could be extracted automatically based on information about the program which is extracted during the automatic parsing of the programs with state of the art parsing techniques. In order to make this diagram more meaningful, the user of the system is allowed to give user-friendly names to the processes. For instance, a routine or paragraph or method called 0040-PROC-APP could be renamed by the user as simply the “Process Application” process. The diagram will visually show the interaction between the processes, indicating for instance the order in which they are run or how they interact with one another. The following table illustrates how rules could be presented in such a “Process Application”.

The first column of the table shows processes in the application. The second column shows the outline of the process and where in the process the rules are involved. The third column shows the rules themselves.

[image]

[image]

[image]

Once the diagram is created, the system will also graphically attach the name of every rule implemented in the program to the corresponding routines which contain the fragments of the code that implement the rule. It may show, for example that the “Store application data” process will run after the “Verify application” process and that the “Phone number should be 7 digits” rule is invoked by the “Verify application” process, while the “No duplicate applications allowed” is invoked by the “Store application data” process. FIG. 6 shows a possible implementation of the rule contextualization described here.

Having thus generally described the invention, the same will become better understood from the appended claims in which it is set forth in a non-limiting manner.

1. A method of identifying business rules relating to inputs in program code of a program, comprising:
identifying all input ports in the program code;
determining the data structure associated with each input port;
for each field in each input port, determining the outgoing data flow;
for each field in the data flow, determining if there is a test used to branch in the program; and
if a test exists, creating a validation rule, and storing the rule.

2. The method of claim 1, wherein said storing of the rule further comprises storing information about where the rule is located.

3. The method of claim 2, wherein said information includes the program name, starting line number and ending line number.

4. The method of claim 1, wherein said business rules are identified by automatically parsing the code of a program with a parsing program.

5. The method of claim 1, wherein said business rules are identified by manually inspecting the code of a program.

6. The method of claim 1, further comprising classifying the business rule, and storing pointers back to the program code in the program.

7. The method of claim 1, wherein the stored rule is given a name selected from one of the name of the input data port and the field being tested.

8. A method of identifying business rules relating to outputs in program code of a program, comprising:
identifying all output ports in the program code;
determining the data structure associated with each output port;
for each field in each output port, determining the computation path; and
determining whether the computation path is not empty, and if the computation path is not empty, creating a computation rule, and storing the rule.

9. The method of claim 8, wherein said determining of the computation path further comprises determining all statements required to arrive at the value of a field before it is sent out of the program through the output data port.

10. The method of claim 8, wherein said storing of the rule further comprises storing information about where the rule is located.

11. The method of claim 10, wherein said information includes the program name, starting line number and ending line number.

12. The method of claim 8, wherein said business rules are identified by automatically parsing the code of a program with a parsing program.

13. The method of claim 8, wherein said business rules are identified by manually inspecting the code of a program.

14. The method of claim 8, further comprising classifying the business rule and storing pointers back to the program code in the program.

15. The method of claim 8, wherein the stored rule is given a name selected from one of the names of the output data port and the original field in the output data structure.

16. The method of identifying business rules relating to inputs and outputs in program code of a program, comprising:
identifying all input ports and all output ports in the program code;
determining the data structure associated with each input port and with each output port;
for each field in each input port, determining the outgoing data flow, and for each field in each output port, determining the computation path;
for each field in the input port outgoing data flow, determining if there is a test used to branch in the program and for each field in the data flow of the input ports, creating a validation rule and storing the rule if a test exists; and
for each computation path of each output port, determining if the computation path is not empty, and if the computation path is not empty, creating a computation rule, and storing the rule.

17. The method of claim 16, wherein for each output port, said determining of the computation path further comprises determining all statements required to arrive at the value of a field before it is sent out of the program through an output data port corresponding thereto.

18. The method of claim 16, wherein said storing of the rule further comprises storing information about where the rule is located.

19. The method of claim 18, wherein said information includes the program name, starting line number and ending line number.

20. The method of claim 16, further comprising classifying the business rule, and storing pointers back to the program code.

21. The method of claim 16, wherein the stored rule is given a name selected from one of the name of the data port and the field being tested.

22. A system for identifying business rules relating to inputs and outputs in program, comprising:
an interface constructed for displaying all input ports and all output ports in the program code;
said interface further comprising,
means for determining the data structure associated with each input port and with each output port, means for determining the outgoing data flow for each field in each input port and means for determining the computation path for each field in each output port;
means for determining if there is a test used to branch in the program for each field in the input port outgoing data flow, and means for creating a validation rule and storing the validation rule if a test exists; and
means for determining if the computation path is not empty for each computation path of each output data port, and means for creating a computation rule and for storing the computation rule if the computation path is not empty.

23. The system of claim 22, further comprising means for determining all statements required to arrive at the value of a field before it is sent out of the program through an output data port corresponding thereto.

24. The system of claim 22 wherein said means for storing said validation rules and said means for storing said computation rules are further adapted for storing information about where in the program the rule is located.

25. The system of claim 24, wherein said means for storing said validation rules and said means for storing said computation rules are further adapted for storing as part of said information, the program name, starting line number and ending line number.

26. The system of claim 24, further comprising means for classifying the business rules and for storing pointers back to the program code.
